(19) United States
(12) Patent Application Publication
(10) Pub. No.: US 2022/0405714 A1
(43) Pub. Date: Dec. 22, 2022

(54) Scheduling a Workforce for a Forecasted Event According to Timing of the Forecasted Event

(71) Applicant: ZEBRA TECHNOLOGIES CORPORATION, Lincolnshire, IL (US)

(72) Inventors: Suvarna S. Krishnan, Westwood, MA (US); Vishv Garg, Gurgaon (IN)

(21) Appl. No.: 17/353,211

(22) Filed: Jun. 21, 2021

(51) Int. Cl. G06Q 10/10; G06Q 10/04; G06N 7/00

(52) U.S. Cl. CPC G06Q 10/1097; G06Q 10/04; G06N 7/005

(57) ABSTRACT

An event scheduling system is described herein. The event scheduling system may configure a forecast model to utilize a plurality of time-based parameters. The event scheduling system may receive historical data that identifies historical workforce arrangements in association with a performance parameter of an organization. The event scheduling system may receive a request to schedule a workforce in association with a forecasted event. The event scheduling system may cause a forecast model to indicate a workforce arrangement for the organization during a time frame associated with the forecasted event. The event scheduling system may schedule a set of resources for work during the time frame in accordance with the workforce arrangement.

### BACKGROUND

An organization (e.g., a retailer, health-care facility, or other type of enterprise) may attempt to schedule and/or configure a workforce according to demand during certain hours of the day, days of the week, weeks of the month, months of the year, and so on. Various types of events, especially unexpected events can cause fluctuations in demand that can result in overstaffing or understaffing during time periods associated with these types of events. Accordingly, there is a need to be able to identify and/or determine adjustments to a workforce arrangement in the event that one or more of these types events occurs during certain time periods of the day, week, month, or year.

### SUMMARY

In some implementations, a method for scheduling a workforce for a forecasted event includes configuring a forecast model to utilize a plurality of time-based parameters; receiving historical data that identifies historical workforce arrangements in association with a performance parameter of an organization, wherein the historical data indicates that the historical workforce arrangements were configured in association with the plurality of time-based parameters, and wherein the historical data indicates event statuses associated with the plurality of time-based parameters; receiving a request to schedule the workforce in association with the forecasted event; causing the forecast model to indicate a workforce arrangement for the organization during a time frame associated with the forecasted event, wherein the forecast model is configured to: identify an event type of the forecasted event, determine, based on the event type of the forecasted event and the time frame, a subset of the historical workforce arrangements that are associated with an event status that corresponds to the event type and that were configured in association with a time-based parameter that corresponds to the time frame, determine, for the performance parameter, an impact score associated with the event type and the time-based parameter, and output the workforce arrangement based on the impact score and corresponding values of the performance parameter that are associated with the historical workforce arrangements; and scheduling a set of resources for work during the time frame in accordance with the workforce arrangement.

In some implementations, a device includes one or more memories; and one or more processors, coupled to the one or more memories, configured to: receive historical data that identifies historical workforce arrangements in association with a performance parameter of an organization; configure a forecast model to utilize a plurality of time-based parameters to analyze the performance parameter in association with event statuses; receive a request to schedule a workforce in association with a forecasted event; identify, within the request, an event type of the forecasted event; cause the forecast model to: determine, based on the event type and a time frame of the forecasted event, a subset of the historical workforce arrangements that are associated with an event status that corresponds to the event type and that were configured in association with a time-based parameter that corresponds to the time frame, determine, for the performance parameter, an impact score associated with the event type and the time-based parameter, and determine a workforce arrangement based on the impact score and corresponding values of the performance parameter that are associated with the historical workforce arrangements; select, based on the workforce arrangement, a set of resources for work during the time frame; and schedule the set of resources for work during the time frame in accordance with the workforce arrangement.

In some implementations, a tangible machine-readable medium storing a set of instructions includes one or more instructions that, when executed by one or more processors of a device, cause the device to: receive configuration information associated with one or more workforce arrangements for an organization; configure, based on the configuration information, a linear regression model to utilize event statuses and a plurality of time-based parameters in association with a performance parameter of the organization, wherein the event statuses, the plurality of time-based parameters, and the performance parameter are identified in the configuration information; receive a request to determine a workforce arrangement for a forecasted event during a time frame; analyze, based on an event type of the forecasted event and the time frame, historical data that identifies historical workforce arrangements in association with the performance parameter, the plurality of time-based parameters, and the event statuses; determine a subset of the historical workforce arrangements that are associated with an event status that corresponds to the event type; determine, based on the subset of the historical workforce arrangements and using the linear regression model, an impact score associated with the event type, wherein the impact score is indicative of an effect that an occurrence of an event, corresponding to the event type, has on the performance parameter; determine the workforce arrangement based on the impact score, the time frame, and a time-based parameter, of the plurality of time-based parameters, that corresponds to the time frame; and provide, to a user device associated with the organization, an indication of the workforce arrangement.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate implementations of concepts disclosed herein, and explain various principles and advantages of those implementations.

FIG. 1 is a diagram of an example implementation associated with analyzing historical workforce arrangements in accordance with one or more examples described herein.

FIG. 2 is a diagram of an example implementation associated with scheduling a workforce arrangement for a forecasted event in accordance with one or more examples described herein.

FIG. 3 is a diagram of an example implementation described herein.

FIG. 4 is a diagram of an example environment in which systems and/or methods described herein may be implemented.

FIG. 5 is a diagram of example components of one or more devices of FIG. 4.

FIG. 6 is a flowchart of an example process relating to scheduling a workforce for a forecasted event according to timing of the forecasted event.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations described herein.

The apparatus and method elements have been represented where appropriate by conventional symbols in the drawings, showing only those specific details that are pertinent to understanding the implementations described herein so as not to obscure the disclosure with details that will be readily apparent to those of ordinary skill in the art having the benefit of the description herein.

### DETAILED DESCRIPTION

The following detailed description of example implementations refers to the accompanying drawings. The same reference numbers in different drawings may identify the same or similar elements.

In some cases, an individual associated with an organization (e.g., an employee of the organization or an associate of the organization, such as a partner, client, vendor, or supplier of the organization) may need (or want) to predict an impact that an event may have on an organization. The event may correspond to one or more types of events that occur irregularly and/or unexpectedly. For example, the event may correspond to or involve a type of event that is not controlled or triggered by an action of the organization, such as a weather-based event, a natural disaster, and/or an execution of a governmental order or regulation, among other examples that may affect economic aspects or operations of the organization. In some cases, the event corresponds to a type of event that is not controlled or triggered by a certain department or individual of the organization, but triggered by another department or individual of the organization, such as a previously unscheduled promotional event, marketing campaign, or other similar type of event that may affect certain aspects or operations of the organization.

Accordingly, as an example, a manager (e.g., a staffing manager or operations manager of the organization) that is assigned to schedule and/or allocate resources for future time periods at one or more locations of operation (e.g., retail locations, service providing locations, logistics locations, headquarters, or other types of locations) associated with the organization may be unaware that one or more of the above events may occur during one or more of the future time periods and/or at one or more of the locations. In some cases, to determine a workforce arrangement, schedule a workforce, and/or allocate resources for the future time periods, the manager may use a model with historical information associated with historical time periods that correspond to the future time periods (e.g., corresponding days of the week, weeks of the month, weeks of the year, months of the year, or other types of recurring time periods). However, certain such models and/or historical information may not indicate whether the historical time periods were associated with certain types of events, thereby causing the models to be incapable of accurately determining a workforce arrangement or scheduling a workforce to sufficiently maintain and/or improve a performance-based parameter of the organization.

Some implementations described herein provide an event scheduling system that enables an organization (e.g., an individual or department of the organization) to consider an impact that a certain type of event, during a certain time period, may have on a particular parameter of the organization (e.g., a performance parameter, such as a sales-based parameter, a service providing parameter, and/or the like). For example, the event scheduling system may include or be associated with a forecast model that is configured to analyze historical data associated with historical workforce arrangements in association with a performance parameter of the organization. The historical data may include event statuses associated with certain time-based parameters associated with the historical workforce arrangements. The event statuses may indicate whether the historical workforce arrangements were configured in accordance with the time-based parameters and/or occurrences of events associated with one or more types of events that are anomalous, unpredictable, and/or uncontrollable.

In this way, the event scheduling system, for a forecasted event, may determine a workforce arrangement (e.g., an optimal workforce arrangement as determined by the forecast model) and/or schedule the workforce arrangement to permit the organization to more accurately maintain and/or manage one or more operations of the organization than would otherwise be determined or scheduled without consideration of a type or time frame of the forecasted event. For example, the event scheduling system may indicate a workforce arrangement for a future time period if a forecasted event is to (or might) occur during the time period that is more optimal than workforce arrangements indicated by other systems that do not consider a time of the event or a time frame of the event.

Although one or more examples are described in connection with scheduling a workforce for a forecasted event (or potential occurrence of an event), such examples may similarly apply to other types of operations of an organization that may involve an analysis of a forecasted event (e.g., inventory management, budget management, marketing management, and/or transportation or other logistics management, among other examples).

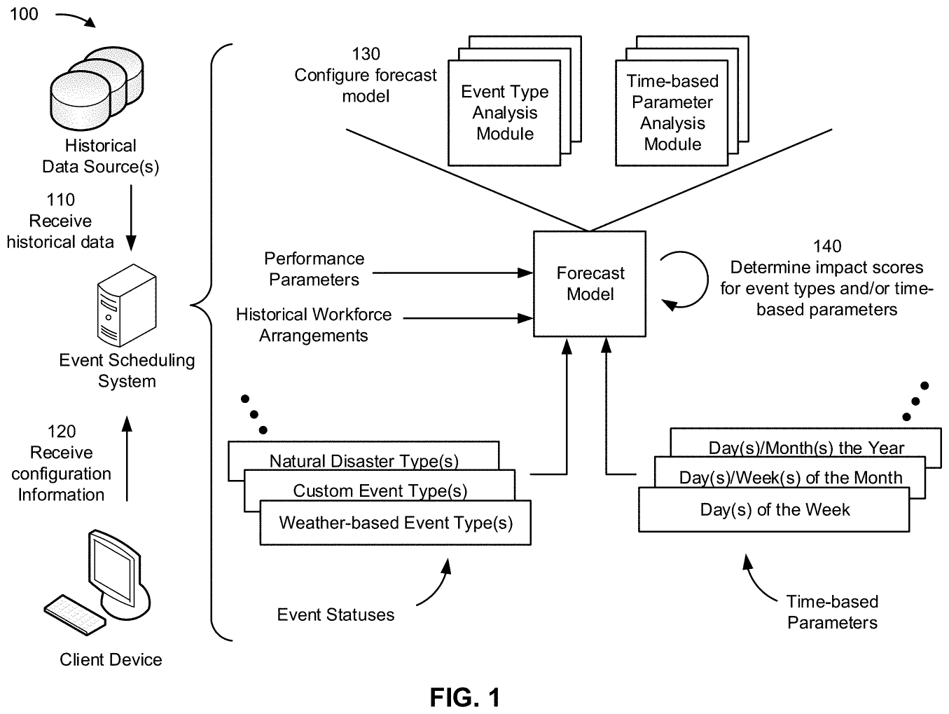

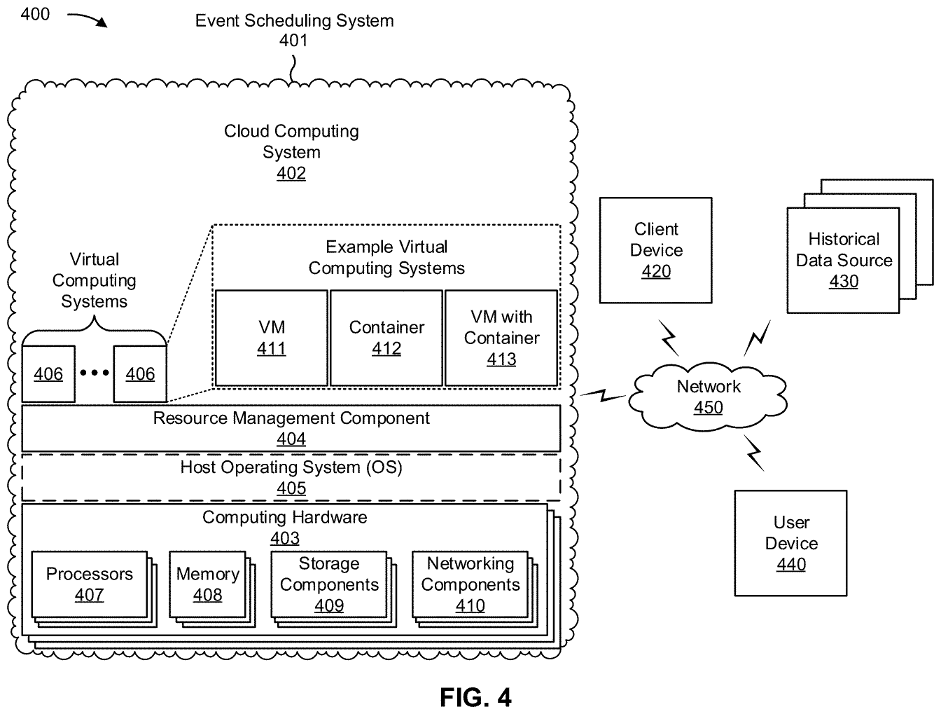

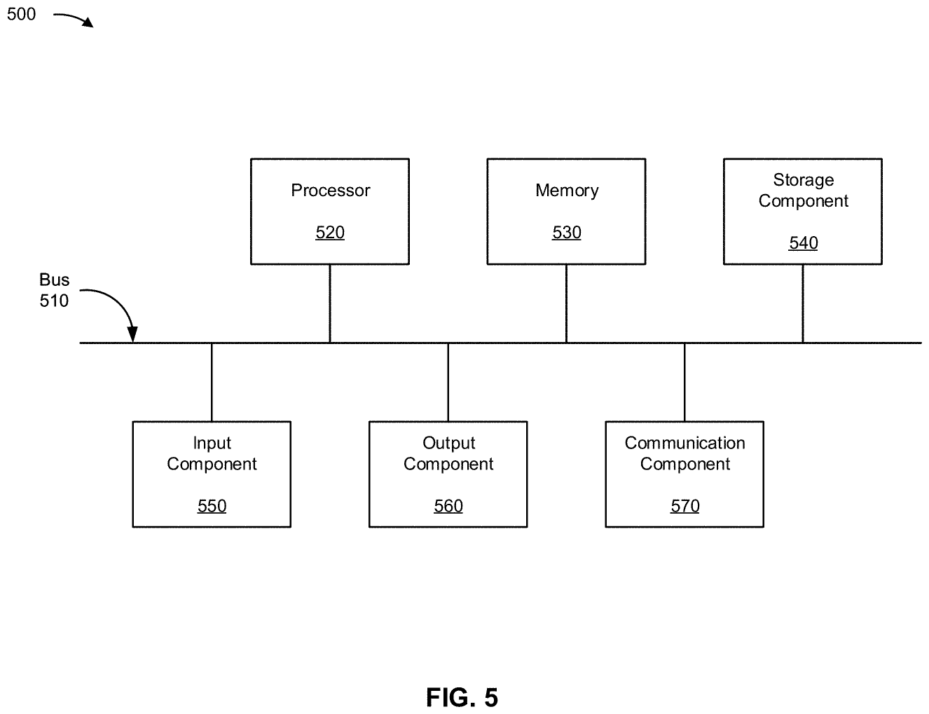

FIG. 1 is a diagram of an example implementation 100 associated with analyzing historical workforce arrangements in accordance with one or more examples described herein. As shown in FIG. 1, example implementation 100 includes an event scheduling system, one or more historical data sources, and a client device. The event scheduling system may include or be associated with a forecast model that includes an event type module and/or a time-based parameter module. These devices are described in more detail below in connection with FIG. 4 and FIG. 5.

As shown in FIG. 1, and by reference number 110, the event scheduling system may receive historical data from the historical data sources. One or more of the historical data sources may be associated with an organization and configured to store and/or maintain historical information associated with the organization. Additionally, or alternatively, one or more of the historical data sources may be associated with a third party that is configured to provide information associated with certain types of events described herein.

In some implementations, the event scheduling system periodically obtains the historical data. For example, the event scheduling system may obtain the historical data daily, weekly, monthly, and so on. Additionally, or alternatively, the event scheduling system may receive the historical data based on a request from the client device and/or a request from a user device, as described elsewhere herein. Such a request may correspond to a request to determine a workforce arrangement and/or schedule a workforce (or a set of resources of a workforce arrangement), as described elsewhere herein.

The historical data may identify historical workforce arrangements in association with a performance parameter of an organization. The performance parameter may correspond to one or more customer-service based parameters (e.g., timeliness of providing a service, customer wait-times for receiving a service, or the like). Additionally, or alternatively, the performance parameter may be associated with one or more other parameters of the organization that may be monitored, such as sales/invoice numbers, inventory numbers, and/or resource availability, among other types of parameters.

The historical data may indicate that the historical workforce arrangements were configured in association with one or more of a plurality of time-based parameters. The time-based parameters may correspond to a time of day (e.g., an hour of the day), a time of week (e.g., a day of the week), a time of month (e.g., a day or week of a month), a time of year (e.g., a day or holiday, week, or month of the year), and so on. The historical data may indicate event statuses associated with the plurality of time-based parameters. The event statuses may be annotated and/or included within the historical data based on a user input and/or based on being determined from information from the historical data sources.

The event statuses may indicate whether a certain type of event occurred in association with the time-based parameters. For example, the event statuses may indicate whether a weather-based event occurred (or a type of the weather-based event, such as a rain storm, a snow storm, a heat wave, a drought, a tornado, and/or a hurricane, among other examples), whether a natural disaster occurred (e.g., a disaster associated with a weather-based event or other type of natural disaster), a health-based event (e.g., an epidemic or pandemic), a governmental-order-based event, and so on. In some implementations, the event statuses may indicate whether the workforce arrangements were configured in association with a certain event involving the organization (e.g., a promotional event, a marketing event, or the like). In this way, the forecast model can be configured to analyze the historical workforce arrangements in association with one or more of the types of events and/or based on the event statuses.

As further shown in FIG. 1, and by reference number 120, the event scheduling system may receive configuration information from the client device. The client device may provide the configuration information based on a user input (e.g., an input from an individual associated with the organization). For example, the configuration information may specify one or more parameters that are to be used to configure the forecast model as described herein. For example, the client device may indicate, within the configuration information, certain types of events and/or event statuses that are to be analyzed, certain time-based parameters that are to be analyzed, certain performance parameters that are to be analyzed, certain locations of the organization that are to be analyzed, and/or the like. Additionally, or alternatively, the configuration information may specify an output of the forecast model, such as a workforce arrangement and/or a set of resources that are to be scheduled for a forecasted event, as described herein.

As further shown in FIG. 1, and by reference number 130, the event scheduling system may configure a forecast model. For example, the event scheduling system may configure the model according to the configuration information. The forecast model may include or be associated with a linear regression model that is to analyze a performance parameter of the organization. Accordingly, the event scheduling system may configure the forecast model to include or designate a plurality of parameters that are to be analyzed by the forecast model in accordance with a linear regression analysis. More specifically, the event scheduling system may configure the forecast model by mapping values for a performance parameter to corresponding time-based parameters and/or event types indicated in the configuration information.

The event scheduling system may configure the time-based parameter analysis module of the forecast model to utilize a plurality of time-based parameters. For example, the event scheduling system may identify the plurality of time-based parameters within the configuration information and/or within one or more user inputs that identify the plurality of time-based parameters, and designate the plurality of time-based parameters that are to be mapped to the performance parameter for the linear regression analysis. Additionally, or alternatively, the event scheduling system may configure the event type analysis module of the forecast model to utilize event statuses indicated in the configuration information. Accordingly, the event scheduling system may designate one or more event statuses that are to be mapped to values of the performance parameter for the linear regression analysis.

In some implementations, the event scheduling system may configure the forecast model to provide an output associated with a particular operation of an organization. For example, the event scheduling system may configure the forecast model to provide a workforce arrangement and/or a set of resources for use in association with the workforce arrangement. More specifically, the forecast model may be configured to identify, for a type of forecast event during a particular time frame, a quantity of individuals that are to perform one or more tasks, a quantity of individuals for a particular role of the organization that are to perform one or more particular types of tasks, an allocation of equipment that is to operate, and/or an allocation of a particular type of equipment that is to perform one or more particular types of operations during the time frame.

In some implementations, the forecast model may be configured to analyze an event based on portions of a time period associated with an event. For example, the forecast model may be configured to analyze an impact score relative to time periods that are before, during, and/or after historical occurrences of a particular type of event. In this way, the forecast model may correspondingly analyze and/or forecast effects on a performance parameter of the organization before, during, or after a forecasted event in association with a time frame of the forecasted event (and/or corresponding time-based parameters of the forecasted event).

The forecast model may be configured within an application associated with the event scheduling system and/or that may be downloaded and/or installed on a user device described elsewhere herein. In this way, the forecast model may be utilized, via the application, to determine a workforce arrangement and/or schedule a workforce for a forecasted event, as described elsewhere herein.

As further shown in FIG. 1, and by reference number 140, the event scheduling system may determine impact scores for event types and/or time-based parameters. For example, the event scheduling system may utilize the forecast model to determine an impact score for a particular event type based on one or more of the time-based parameters. The impact score may be indicative of an effect that an occurrence of an event, corresponding to the event type, has on a performance parameter. In some implementations, the impact score may be specific to the occurrence of the event during a particular time period associated with one or more of the time-based parameters.

To determine an impact score for a particular event type identified in the configuration information, the forecast model (e.g., via the event type analysis module) may determine a subset of the historical workforce arrangements that are associated with an event status that corresponds to the event type. Additionally, or alternatively, the forecast model may determine the impact score relative to one or more time-based parameters associated with a time frame of occurrences of the event type. The forecast model may determine the impact score based on a difference between (and/or ratio of) a first value (e.g., an average or a value determined from a linear regression analysis) that is associated with the performance parameter during an occurrence of the event type and a second value that is associated with the performance parameter during occurrences that are not associated with the event type.

As a more specific example, if the performance parameter corresponds to an invoice parameter (e.g., a quantity of invoices and/or a value of invoices), the forecast model may be configured to determine an impact score for the invoice parameter for a particular type of event, which is indicative of how an occurrence of the event may affect the invoice parameter (e.g., may affect a quantity of invoices and/or may affect a value of the invoices). Furthermore, the impact score for the invoices may be associated with a time-based parameter of historical occurrences of the event and how a time-based parameter (e.g., a time of day, a day of week, a day of the year, and so on) may affect the invoices. Additionally, or alternatively, the impact score may be combined with impact scores for the performance characteristic that are determined based on the time-based parameters.

In this way, a forecast model may be configured by the event scheduling system, the client device, and/or another system to permit the event scheduling system to determine a workforce arrangement or schedule a workforce to maintain and/or manage a performance parameter during a forecasted event, as described elsewhere herein.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

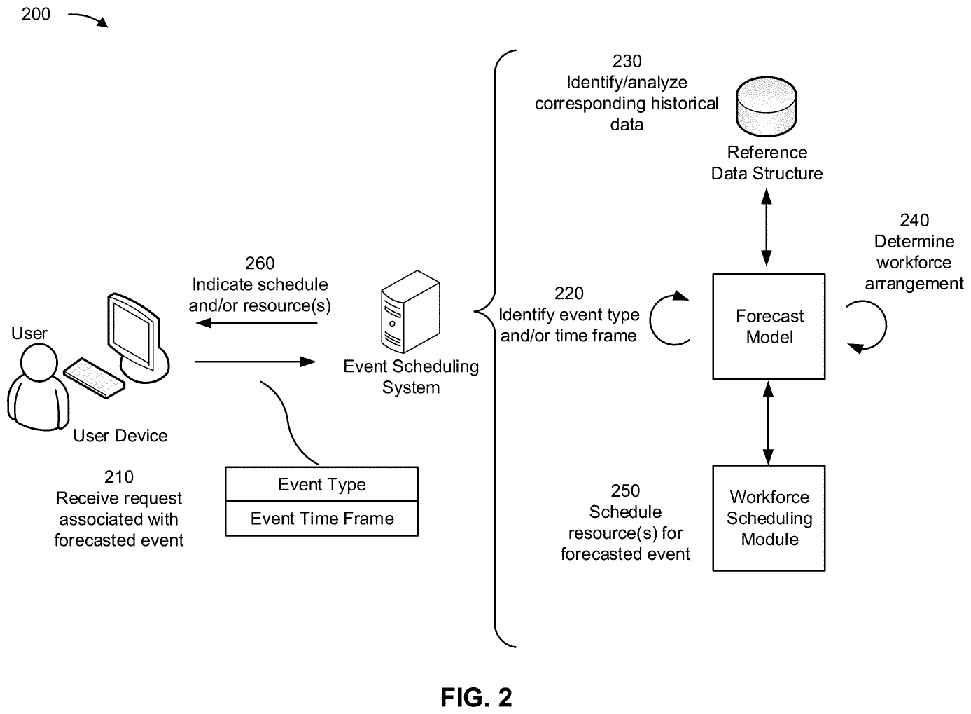

FIG. 2 is a diagram of an example implementation 200 associated with scheduling a workforce arrangement for a forecasted event in accordance with one or more examples described herein. As shown in FIG. 2, example implementation 200 includes an event scheduling system (e.g., the event scheduling system of example implementation 100) and a user device. The event scheduling system may include a forecast model, a workforce scheduling module, and a reference data structure. These devices are described in more detail below in connection with FIG. 4 and FIG. 5.

As shown in FIG. 2, and by reference number 210, the event scheduling system may receive a request associated with a forecasted event. For example, as shown, the event scheduling system may receive the request from the user device. The request may correspond to a request to determine a workforce arrangement for a forecasted event and/or a request to schedule a workforce in association with a forecasted event.

The request may be received in association with a user input (e.g., from a user, such as a manager seeking to determine a workforce arrangement and/or allocation of resources of the organization) to the user device. As shown in example implementation 200, the request may include one or more event types and/or one or more event time frames (e.g., future time periods during which a forecasted event may occur and/or future time periods associated with a particular forecasted event).

As further shown in FIG. 2, and by reference number 220, the event scheduling system may identify the event type and/or the time frame. For example, the event scheduling system may analyze the request and identify an event type of a forecasted event and/or a time frame of the forecasted event in order to determine a workforce arrangement and/or schedule a workforce using the forecast model, as described herein.

As further shown in FIG. 2, and by reference number 230, the event scheduling system may identify and/or analyze corresponding historical data. For example, the event scheduling system may perform a look up operation of the reference data structure, to identify historical data that is associated with an event status corresponding to the identified event type and/or one or more time-based parameters corresponding to the time frame. The historical data structure may have been configured and/or built in accordance with configuring the forecast model, as described elsewhere herein. Accordingly, the reference data structure may include information that identifies one or more impact scores associated with one or more parameters of the forecast model described herein (e.g., one or more performance parameters, one or more event statuses, one or time-based parameters, one or more workforce arrangements, one or more resource allocations).

Accordingly, the event scheduling system may identify historical workforce arrangements, within the reference data structure, that are associated with an event status of the event type and/or the time-based parameters associated with the time frame. Furthermore, the event scheduling system may identify an impact score associated with the event type and/or time-based parameters associated with the time frame.

As further shown in FIG. 2, and by reference number 240, the event scheduling system may determine a workforce arrangement. For example, in accordance with the configuration of the forecast model, as described elsewhere herein, the event scheduling system may cause the forecast model to determine and/or indicate a workforce arrangement for the organization during the time frame associated with the forecasted event. The workforce arrangement may include a quantity of individuals and/or roles that are to be scheduled to perform one or more tasks, for the organization during the forecasted event. Additionally, or alternatively, the workforce arrangement may identify a set of resources that are to be made available or scheduled to be available to permit the individuals to correspondingly access and/or use the set of resources to perform the one or more tasks.

As described herein, the event scheduling system and/or the forecast model may determine the workforce arrangement based on the impact score associated with the event type and time-based parameters. Furthermore, the event scheduling system and/or the forecast model may determine the workface arrangement based on corresponding values of the performance parameter that are associated with historical workforce arrangements utilized during historical occurrences of the event type. The workforce arrangement may be an optimal workforce arrangement (e.g., optimal according to the configuration of the forecast model) that is arranged to maintain and/or manage the performance parameter during the forecasted event.

As further shown in FIG. 2, and by reference number 250, the event scheduling system may schedule one or more resources for the forecasted event. For example, the event scheduling system may cause the forecast model to output the workforce arrangement and/or automatically schedule individuals and/or a set of resources associated with the determined workforce arrangement. In some implementations, to schedule the workforce arrangement, the event scheduling system, via the workforce scheduling module, may select individuals to work during the time frame and/or a set of resources for work (e.g., for use and/or operation) during the time frame.

The workforce scheduling module may include or be associated with a scheduling data structure (e.g., a calendar system that includes or identifies allocations of resources or schedules of individuals associated with the organization). Accordingly, the event scheduling system may determine, using the scheduling data structure, an availability of a set of resources and/or individuals associated with the organization. Based on the availability of the set of resources (and/or the individuals) indicating that the set of resources are available during the time frame., the event scheduling system may schedule the set of resources for work during the time frame and/or designate the set of resources for use during the time frame.

As further shown in FIG. 2, and by reference number 260, the event scheduling system may indicate a schedule and/or the one or more resources. For example, the event scheduling system may provide a notification that indicates (e.g., via a schedule) that one or more individuals are scheduled to work during a time frame of the forecasted event and/or that identifies one or more resources that are designated for use during the time frame of the forecasted event. In some implementations, the event scheduling system may provide a schedule associated with a selected set of resources for the forecasted event to indicate one or more allocations of the set of resources during the time frame.

In some implementations, the scheduling data structure of the workforce scheduling module may include identification information associated with individuals (e.g., a name of an individual, a device identifier associated with a device of the individual, and/or the like) and/or identification information associated with resources (e.g., equipment identifiers) in the scheduling data structure of the workforce scheduling module. Accordingly, based on the identified identification information of the set of scheduled resources, the event scheduling system may identify a user device associated with a representative (e.g., one or more of the individuals) of the organization that is scheduled to work during the forecasted event. Correspondingly, the event scheduling system may provide a notification to the user device of the representative to indicate that the representative has been scheduled to work during the time frame in accordance with the workforce arrangement.

In this way, the event scheduling system may automatically determine a workforce arrangement for a forecasted event and/or schedule resources associated with the workforce arrangement to work or be used during a time frame of the forecasted event.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

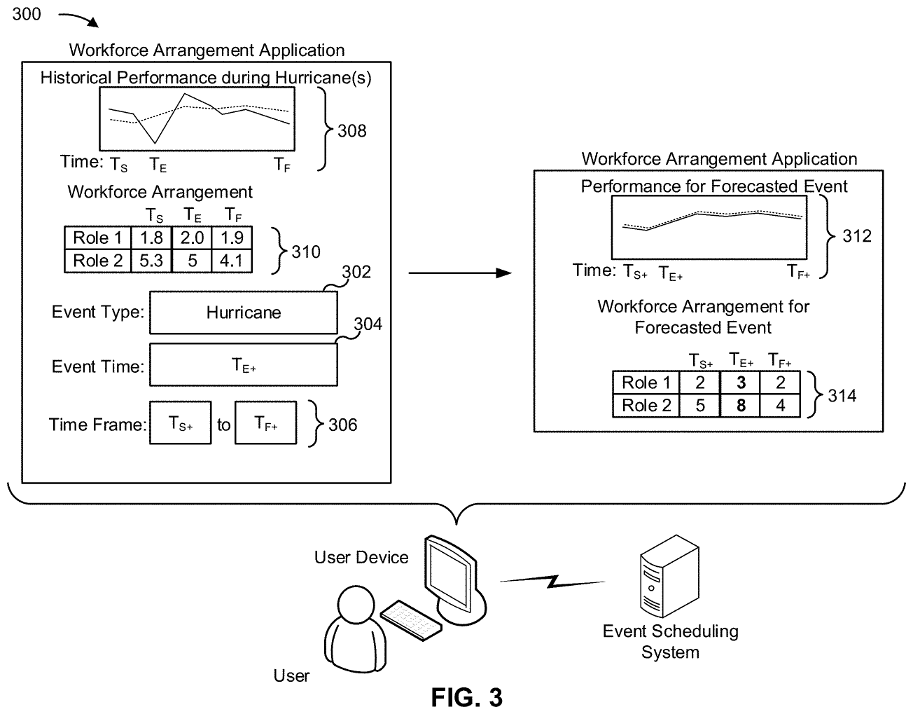

FIG. 3 is a diagram of an example implementation 300 associated with determining a workforce arrangement for a forecasted event in accordance with one or more examples described herein. As shown in FIG. 3, example implementation 300 includes an event scheduling system (e.g., the event scheduling system of example implementation 100 or example implementation 200) and a user device (e.g., the user device of example implementation 200).

As shown in FIG. 3, an application (shown as “Workforce Arrangement Application”) associated with the event scheduling system may be installed on the user device and/or utilized by a user to determine and/or schedule a workforce for a forecasted event, as described elsewhere herein. The application may permit the user to indicate an event type 302, an event time 304, and/or a time frame 306 of a forecasted event. Accordingly, based on the user entering the event type (shown as a Hurricane), the event time (shown as T_{E+}) and the time frame (shown as T_{S+} to T_{F+}), for the forecasted event, the application may indicate historical performance information 308 and/or information associated with historical workforce arrangements 310 associated with historical occurrences of the event (e.g., past hurricanes) associated with corresponding time-based parameters. The corresponding time-based parameters are shown as Ts (corresponding to T_{S+}), T_{E} (corresponding to T_{E+}), and T_{F} (corresponding to T_{F+}). Furthermore, a quantity of individuals (e.g., averages or linear regression values) may be shown at corresponding times for a first role (Role 1) and a second role (Role 2). Furthermore, based on the user requesting the application to determine a workforce arrangement for the forecasted event, the application may indicate a forecasted performance for the forecasted event 312 and a workforce arrangement 314 for the time frame of the forecasted event. More specifically, the application may indicate that a workforce arrangement should include an increased quantity of individuals (from 2 to 3) in the first role and an increased quantity of individuals (from 5 to 8) for the second role during the event time.

In some implementations, the event scheduling system may identify one or more portions of a time frame associated with the forecasted event. For example, a first portion of the time frame may correspond to an interval that is before a start of the forecasted event (which may be a time period corresponding to T_{S+} to a start time of T_{E+}) and that is associated with a first time-based parameter (e.g., a day of the week of T_{S+}). A second portion of the time frame may correspond to an interval that is after the start of the forecasted event (which may be a start time of T_{E+}), before an end of the forecasted event (which may be an end time of T_{E+}), and associated with a second time-based parameter (e.g., a day of the week of the start time or end time of T_{E+}). A third portion of the time frame may correspond to an interval that is after the end of the forecasted event (which may be a time period corresponding to an end time of T_{E+} to T_{F+}) and that is associated with a third time-based parameter (e.g., a day of the week of T_{F+}).

Accordingly, as shown, the application (and/or forecast model) may output a workforce arrangement to identify a first allocation of resources for the first portion (e.g., 2 individuals for Role 1 and 5 individuals for Role 2 at T_{S+}), a second allocation of resources for the second portion (e.g., 3 individuals for Role 1 and 8 individuals for Role 2 at T_{E+}) and a third allocation of resources for the third portion (e.g., 2 individuals for Role 1 and 4 individuals for Role 2 at T_{F+}). Furthermore, the application and/or the forecast model may determine the first allocation, the second allocation, and the third allocation according to the first time-based parameter, the second time-based parameter, and the third time-based parameter, respectively.

In this way, the forecast model, as described herein, may permit a user, via an application, to determine a workforce arrangement and/or schedule a workforce as described herein.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a event scheduling system 401, which may include one or more elements of and/or may execute within a cloud computing system 402. The cloud computing system 402 may include one or more elements 403-413, as described in more detail below. As further shown in FIG. 4, environment 400 may include a client device, one or more historical data sources 430, a user device 440, and/or a network 450. Devices and/or elements of environment 400 may interconnect via wired connections and/or wireless connections.

The cloud computing system 402 includes computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

Computing hardware 403 includes hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, one or more storage components 409, and/or one or more networking components 410. Examples of a processor, a memory, a storage component, and a networking component (e.g., a communication component) are described elsewhere herein.

The resource management component 404 includes a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 411. Additionally, or alternatively, the resource management component 404 may include a container manager, such as when the virtual computing systems 406 are containers 412. In some implementations, the resource management component 404 executes within and/or in coordination with a host operating system 405.

A virtual computing system 406 includes a virtual environment that enables cloud-based execution of operations and/or processes described herein using computing hardware 403. As shown, a virtual computing system 406 may include a virtual machine 411, a container 412, or a hybrid environment 413 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the event scheduling system 401 may include one or more elements 403-413 of the cloud computing system 402, may execute within the cloud computing system 402, and/or may be hosted within the cloud computing system 402, in some implementations, the event scheduling system 401 may not be cloud-based (e.g., may be implemented outside of a cloud computing system) or may be partially cloud-based. For example, the event scheduling system 401 may include one or more devices that are not part of the cloud computing system 402, such as device 500 of FIG. 5, which may include a standalone server or another type of computing device. The event scheduling system 401 may perform one or more operations and/or processes for determining and/or scheduling a workforce for a forecasted event described in more detail elsewhere herein.

The client device 420 includes one or more devices capable of receiving, generating, storing, processing, and/or providing information associated with scheduling a workforce for a forecasted event according to timing of the forecasted event, as described elsewhere herein. The client device 420 may include a communication device and/or a computing device. For example, the client device 420 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The historical data source 430 includes one or more devices capable of receiving, generating, storing, processing, and/or providing information associated with historical workforce arrangements and/or historical data associated with the historical workforce arrangements, as described elsewhere herein. The historical data source 430 may include a communication device and/or a computing device. For example, the historical data source 430 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The historical data source 430 may communicate with one or more other devices of environment 400, as described elsewhere herein.

The user device 440 includes one or more devices capable of receiving, generating, storing, processing, and/or providing information associated with a schedule of a workforce arrangement for a forecasted event, as described elsewhere herein. The user device 440 may include a communication device and/or a computing device. For example, the user device 440 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

Network 450 includes one or more wired and/or wireless networks. For example, network 450 may include a cellular network, a public land mobile network (PLMN), a local area network (LAN), a wide area network (WAN), a private network, the Internet, and/or a combination of these or other types of networks. The network 450 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to the event scheduling system 401, one or more of the elements 403-413, the client device 420, the historical data source 430, and/or the user device 440. In some implementations, the event scheduling system 401, one or more of the elements 403-413, the client device 420, the historical data source 430, and/or the user device 440 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

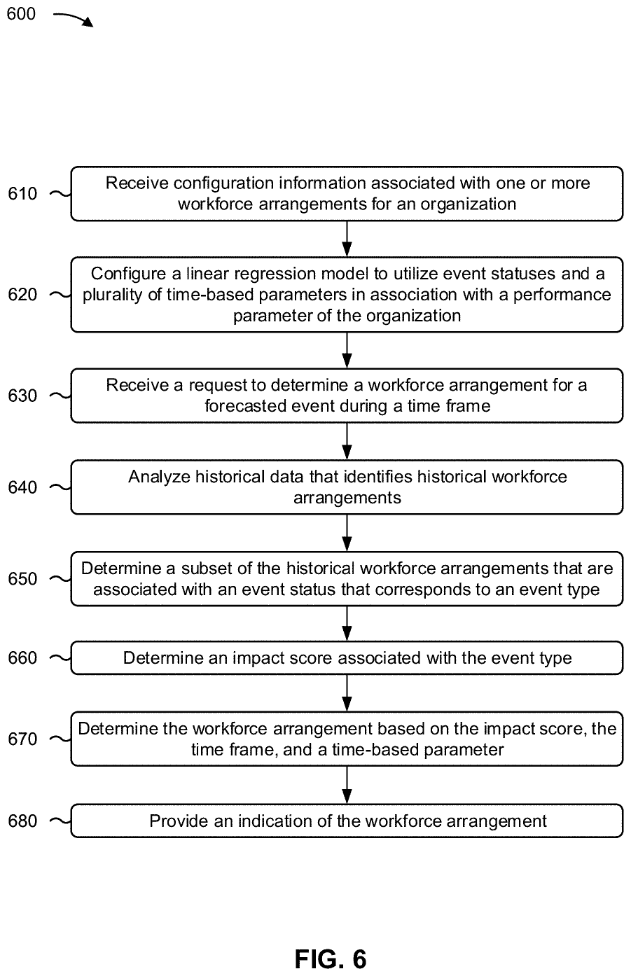

FIG. 6 is a flowchart of an example process 600 associated with scheduling a workforce for a forecasted event. In some implementations, one or more process blocks of FIG. 6 may be performed by an event scheduling system (e.g., the event scheduling system 401). In some implementations, one or more process blocks of FIG. 6 may be performed by another device or a group of devices separate from or including the event scheduling system, such as a client device (e.g., the client device 420), a historical data source (e.g., the historical data source 430), and/or a user device (e.g., the user device 440). Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include receiving configuration information associated with one or more workforce arrangements for an organization (block 610). For example, the event scheduling system may receive configuration information associated with one or more workforce arrangements for an organization, as described above. The configuration information may identify corresponding resource allocations of the one or more workforce arrangements, a performance parameter, a plurality of time-based parameters, and corresponding event types of the event statuses.

As further shown in FIG. 6, process 600 may include configuring a linear regression model to utilize event statuses and a plurality of time-based parameters in association with a performance parameter of the organization (block 620). For example, the event scheduling system may configure, based on the configuration information, a linear regression model to utilize event statuses and a plurality of time-based parameters in association with a performance parameter of the organization, as described above. In some implementations, the event statuses, the plurality of time-based parameters, and the performance parameter may be identified in the configuration information.

As further shown in FIG. 6, process 600 may include receiving a request to determine a workforce arrangement for a forecasted event during a time frame (block 630). For example, the event scheduling system may receive a request to determine a workforce arrangement for a forecasted event during a time frame, as described above.

As further shown in FIG. 6, process 600 may include analyzing historical data that identifies historical workforce arrangements (block 640). For example, the event scheduling system may analyze, based on an event type of the forecasted event and the time frame, historical data that identifies historical workforce arrangements in association with the performance parameter, the plurality of time-based parameters, and the event statuses, as described above. In some implementations, the historical data is stored in a data structure that maps the historical workforce arrangements to corresponding values of the performance parameter, corresponding time-based parameters of the plurality of time-based parameters, and corresponding event types associated with the event statuses.

As further shown in FIG. 6, process 600 may include determining a subset of the historical workforce arrangements that are associated with an event status that corresponds to the event type (block 650). For example, the event scheduling system may determine a subset of the historical workforce arrangements that are associated with an event status that corresponds to the event type, as described above.

As further shown in FIG. 6, process 600 may include determining an impact score associated with the event type (block 660). For example, the event scheduling system may determine, based on the subset of the historical workforce arrangements and using the linear regression model, an impact score associated with the event type, as described above. The impact score may be indicative of an effect that an occurrence of an event, corresponding to the event type, has on the performance parameter. In some implementations, the impact score may be determined based on a difference between a first value that is associated with the performance parameter during an occurrence of the event type and a second value that is associated with the performance parameter during occasions that are not associated with the event type.

As further shown in FIG. 6, process 600 may include determining the workforce arrangement based on the impact score, the time frame, and a time-based parameter (block 670). For example, the event scheduling system may determine the workforce arrangement based on the impact score, the time frame, and a time-based parameter, as described above. The time-based parameter may be a time-based parameter of the plurality of time-based parameters that corresponds to the time frame.

As further shown in FIG. 6, process 600 may include providing an indication of the workforce arrangement (block 680). For example, the event scheduling system may provide, to a user device associated with the organization, an indication of the workforce arrangement, as described above. The indication of the workforce arrangement may identify a quantity of individuals that are to perform one or more tasks during the time frame, a quantity of individuals for a particular role of the organization that are to perform one or more particular types of tasks during the time frame, an allocation of equipment that is to operate during the time frame, and/or an allocation of a particular type of equipment that is to perform one or more particular types of operations during the time frame. In some implementations, the event scheduling system may schedule a set of resources for work during the time frame in accordance with the workforce arrangement.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

In the foregoing disclosure, specific embodiments have been described. However, one of ordinary skill in the art will appreciate that various modifications and changes can be made without departing from the scope of the invention as set forth in the claims below. Accordingly, the specification and figures are to be regarded in an illustrative rather than a restrictive sense, and all such modifications are intended to be included within the scope of present disclosure. Additionally, the described embodiments/examples/implementations should not be interpreted as mutually exclusive, and should instead be understood as potentially combinable if such combinations are permissive in any way. In other words, any feature disclosed in any of the aforementioned examples or implementations may be included in any of the other aforementioned examples or implementations.

As used herein, the term “component” is intended to be broadly construed as hardware, firmware, and/or a combination of hardware and software. As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, or the like) on which machine-readable instructions (e.g., code in the form of, for example, software and/or firmware) can be stored. The instructions may be stored for any suitable duration of time, such as permanently, for an extended period of time (e.g., while a program associated with the instructions is executing), or for a short period of time (e.g., while the instructions are cached, during a buffering process, or the like). Further, as used herein, each of the terms “tangible machine-readable medium,” “non-transitory machine-readable medium” and “machine-readable storage device” is expressly defined to exclude propagating signals. That is, as used in any claim herein, a “tangible machine-readable medium,” a “non-transitory machine-readable medium,” and a “machine-readable storage device,” or the like, should not be interpreted as being implemented as a propagating signal.

As used herein, satisfying a threshold may, depending on the context, refer to a value being greater than the threshold, greater than or equal to the threshold, less than the threshold, less than or equal to the threshold, equal to the threshold, not equal to the threshold, or the like.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, as used herein, relational terms such as first and second, top and bottom, or the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ...a” does not, without more constraints, preclude the existence of additional identical elements in the process, method, article, or apparatus that comprises, has, includes, contains the element.

The terms “a” and “an” are defined as one or more unless explicitly stated otherwise herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

The abstract of the disclosure is provided to allow the reader to quickly ascertain the nature of the technical disclosure. It is submitted with the understanding that it will not be used to interpret or limit the scope or meaning of the claims. In addition, in the foregoing description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A method for scheduling a workforce for a forecasted event, comprising:
configuring, by a device, a forecast model to utilize a plurality of time-based parameters;
receiving, by the device, historical data that identifies historical workforce arrangements in association with a performance parameter of an organization,
wherein the historical data indicates that the historical workforce arrangements were configured in association with the plurality of time-based parameters, and
wherein the historical data indicates event statuses associated with the plurality of time-based parameters;
receiving, by the device, a request to schedule the workforce in association with the forecasted event;
causing, by the device, the forecast model to indicate a workforce arrangement for the organization during a time frame associated with the forecasted event,
wherein the forecast model is configured to:
identify an event type of the forecasted event,
determine, based on the event type of the forecasted event and the time frame, a subset of the historical workforce arrangements that are associated with an event status that corresponds to the event type and that were configured in association with a time-based parameter that corresponds to the time frame,
determine, for the performance parameter, an impact score associated with the event type and the time-based parameter, and
output the workforce arrangement based on the impact score and corresponding values of the performance parameter that are associated with the historical workforce arrangements; and
scheduling, by the device, a set of resources for work during the time frame in accordance with the workforce arrangement.

2. The method of claim 1, wherein configuring the forecast model to utilize the plurality of time-based parameters comprises:
identifying, based on receiving one or more user inputs that identify the plurality of time-based parameters, the plurality of time-based parameters within the one or more user inputs; and
mapping values of the performance parameter to corresponding time-based parameters of the plurality of time-based parameters.

3. The method of claim 1, wherein the request is received in a user input and indicates the event type of the forecasted event and the time frame associated with the forecasted event.

4. The method of claim 1, wherein the forecast model is configured to identify, within the workforce arrangement, at least one of:
a quantity of individuals that are to perform one or more tasks during the time frame;
a quantity of individuals for a particular role of the organization that are to perform one or more particular types of tasks during the time frame;
an allocation of equipment that is to operate during the time frame; or
an allocation of a particular type of equipment that is to perform one or more particular types of operations during the time frame.

5. The method of claim 1, wherein the forecast model is configured to determine the impact score based on a difference between a first value that is associated with the performance parameter during an occurrence of the event type and a second value that is associated with the performance parameter during occurrences that are not associated with the event type.

6. The method of claim 1, further comprising:
prior to scheduling the set of resources to be available, determining, using a scheduling data structure, availability of the set of resources,
wherein the set of resources are scheduled based on the availability indicating that the set of resources are available during the time frame.

7. The method of claim 1, wherein scheduling the set of resources comprises at least one of:
providing, to a user device, a notification that indicates that a representative is scheduled to serve in a role for the organization during the time frame, or
providing, to another user device, a schedule associated with the set of resources to indicate one or more allocations of the set of resources during the time frame.

8. The method of claim 1, wherein the forecast model comprises a linear regression model.

9. A device, comprising:
one or more memories; and
one or more processors, coupled to the one or more memories, configured to:
receive historical data that identifies historical workforce arrangements in association with a performance parameter of an organization;
configure a forecast model to utilize a plurality of time-based parameters to analyze the performance parameter in association with event statuses;
receive a request to schedule a workforce in association with a forecasted event;
identify, within the request, an event type of the forecasted event;
cause the forecast model to:
determine, based on the event type and a time frame of the forecasted event, a subset of the historical workforce arrangements that are associated with an event status that corresponds to the event type and that were configured in association with a time-based parameter that corresponds to the time frame,
determine, for the performance parameter, an impact score associated with the event type and the time-based parameter, and
determine a workforce arrangement based on the impact score and corresponding values of the performance parameter that are associated with the historical workforce arrangements;
select, based on the workforce arrangement, a set of resources for work during the time frame; and
schedule the set of resources for work during the time frame in accordance with the workforce arrangement.

10. The device of claim 9, wherein the request indicates the time frame associated with the forecasted event.

11. The device of claim 9, wherein the time frame includes:
a first portion that is before a start of the forecasted event and that is associated with a first time-based parameter of the plurality of time-based parameters;
a second portion that is after the start of the forecasted event and before an end of the forecasted event and that is associated with a second time-based parameter of the plurality of time-based parameters; and
a third portion that is after the end of the forecasted event and that is associated with a third time-based parameter of the plurality of time-based parameters,
wherein the forecast model is configured to output the workforce arrangement to identify a first allocation of resources for the first portion, a second allocation of resources for the second portion, and a third allocation of resources for the third portion,
wherein the first allocation, the second allocation, and the third allocation are determined according to the first time-based parameter, the second time-based parameter, and the third time-based parameter, respectively.

12. The device of claim 9, wherein the workforce arrangement identifies at least one of:
a quantity of individuals that are to perform one or more tasks during the time frame;
a quantity of individuals for a particular role of the organization that are to perform one or more particular types of tasks during the time frame;
an allocation of equipment that is to operate during the time frame; or
an allocation of a particular type of equipment that is to perform one or more particular types of operations during the time frame.

13. The device of claim 9, wherein the one or more processors are further configured to:
identify, based on identification information associated with the set of resources, a user device that is associated with a representative of the organization; and
provide, to the user device, a notification that indicates that the representative is scheduled to perform an operation for the organization during the time frame.

14. The device of claim 9, wherein the forecast model comprises a linear regression model.

15. A tangible machine-readable medium storing a set of instructions, the set of instructions comprising:
one or more instructions that, when executed by one or more processors of a device, cause the device to:
receive configuration information associated with one or more workforce arrangements for an organization;
configure, based on the configuration information, a linear regression model to utilize event statuses and a plurality of time-based parameters in association with a performance parameter of the organization,
wherein the event statuses, the plurality of time-based parameters, and the performance parameter are identified in the configuration information;
receive a request to determine a workforce arrangement for a forecasted event during a time frame;
analyze, based on an event type of the forecasted event and the time frame, historical data that identifies historical workforce arrangements in association with the performance parameter, the plurality of time-based parameters, and the event statuses;
determine a subset of the historical workforce arrangements that are associated with an event status that corresponds to the event type;
determine, based on the subset of the historical workforce arrangements and using the linear regression model, an impact score associated with the event type,
wherein the impact score is indicative of an effect that an occurrence of an event, corresponding to the event type, has on the performance parameter;
determine the workforce arrangement based on the impact score, the time frame, and a time-based parameter, of the plurality of time-based parameters, that corresponds to the time frame; and
provide, to a user device associated with the organization, an indication of the workforce arrangement.

16. The tangible machine-readable medium of claim 15, wherein the configuration information identifies corresponding resource allocations of the one or more workforce arrangements, the performance parameter, the plurality of time-based parameters, and corresponding event types of the event statuses.

17. The tangible machine-readable medium of claim 15, wherein the historical data is stored in a data structure that maps the historical workforce arrangements to:
corresponding values of the performance parameter,
corresponding time-based parameters of the plurality of time-based parameters; and
corresponding event types associated with the event statuses.

18. The tangible machine-readable medium of claim 15, wherein the indication of the workforce arrangement identifies at least one of:
a quantity of individuals that are to perform one or more tasks during the time frame;
a quantity of individuals for a particular role of the organization that are to perform one or more particular types of tasks during the time frame;
an allocation of equipment that is to operate during the time frame; or
an allocation of a particular type of equipment that is to perform one or more particular types of operations during the time frame.

19. The tangible machine-readable medium of claim 15, wherein the impact score is determined based on a difference between a first value that is associated with the performance parameter during an occurrence of the event type and a second value that is associated with the performance parameter during occasions that are not associated with the event type.

20. The tangible machine-readable medium of claim 15, wherein the one or more instructions further cause the device to:
schedule a set of resources for work during the time frame in accordance with the workforce arrangement.
